(19) United States
(12) Patent Application Publication
(10) Pub. No.: US 2023/0136383 A1
(43) Pub. Date: May 4, 2023

(54) SYSTEMS AND METHODS FOR DETECTING FRAUDULENT SHOPPING WEBSITES

(71) Applicant: NORTONLIFELOCK INC., TEMPE, AZ (US)

(72) Inventors: Platon Kotzias, Athens (GR); Iskander Sanchez Rola, Antibes (FR); Kevin Alejandro Roundy, El Segundo, CA (US); Daniel Kats, Culver City, CA (US); Acar Tamersoy, Culver City, CA (US)

(21) Appl. No.: 17/457,145

(22) Filed: Dec. 1, 2021

(30) Foreign Application Priority Data
Nov. 1, 2021 (EP) 21386066.1

(51) Int. Cl. G06Q 30/06; G06Q 30/00; G06F 16/951; G06N 3/08

(52) U.S. Cl. CPC G06Q 30/0609; G06F 16/951; G06N 3/08; G06Q 30/0185

(57) ABSTRACT

The disclosed computer-implemented method for detecting fraudulent shopping websites may include (i) identifying a shopping website that advertises a plurality of allegedly available payment options for completing transactions on the shopping website, (ii) determining, based at least in part on an analysis of the plurality of allegedly available payment options that at least one of the plurality of allegedly available payment options is suspicious, (iii) calculating a trustworthiness score for the shopping website that is based at least in part on the determination that at least one of the allegedly available payment options is suspicious, and (iv) displaying an alert to a user based on the trustworthiness score of the shopping website. Various other methods, systems, and computer-readable media are also disclosed.

### BACKGROUND

Consumers suffer millions of dollars of losses annually to fraudulent online shopping websites. In some cases, a fraudulent shopping website may offer deals that are clearly too good to be true, but in other cases, a fraudulent website may offer deals that a reasonable person might consider to be within the realm of possibility. Some fraudulent shopping websites may take customers’ payments and never provide any products while others may provide products that are far inferior to what was actually advertised. In many cases, it is time-consuming, difficult, or impossible for customers to obtain refunds from fraudulent shopping websites.

While many applications exist to detect fraudulent websites, they often rely on imprecise or outdated methods. For example, a method that flags a website that does not have a secure socket layer certificate may catch some fraudulent shops but will miss the large quantity of fraudulent websites with functioning certificates. Other methods that rely on user reports may protect later users, but not the early users whose reports are relied upon to flag the website as fraudulent. Some methods may analyze the layout or formatting of a website for characteristics that indicate the website was constructed by a specific known scammer, but such methods must be constantly updated as scammers change and improve their website presentation. The present disclosure, therefore, identifies and addresses a need for systems and methods for detecting fraudulent shopping websites.

### SUMMARY

As will be described in greater detail below, the present disclosure describes various systems and methods for detecting fraudulent shopping websites based on an analysis of allegedly available payment options offered by such websites.

In one example, a computer-implemented method for detecting fraudulent shopping websites may include (i) identifying a shopping website that advertises a group of allegedly available payment options for completing transactions on the shopping website, (ii) determining, based at least in part on an analysis of the plurality of allegedly available payment options, that at least one of the allegedly available payment options is suspicious, (iii) calculating a trustworthiness score for the shopping website that is based at least in part on the determination that at least one of the allegedly available payment options is suspicious, and (iv) displaying an alert to a user based on the trustworthiness score of the shopping website.

In some examples, identifying the shopping website that advertises the allegedly available payment options may include identifying the allegedly available payment options by analyzing text of the shopping website. In some examples, analyzing the text of the shopping website may include analyzing the text via a named entity recognition classifier.

In some embodiments, identifying the shopping website that advertises the allegedly available payment options may include identifying the allegedly available payment options by analyzing images on the shopping website. In some examples, analyzing the images on the shopping website may include analyzing the images via a deep learning image classification algorithm.

In some examples, determining that at least one of the plurality of allegedly available payment options is suspicious may include detecting that at least a portion of the allegedly available payment options are non-functional. In addition, detecting that at least a portion of the plurality of allegedly available payment options are non-functional may include attempting to complete a mock transaction with each payment option within the allegedly available payment options. In one embodiment, attempting to complete the mock transaction with each payment option may include (i) detecting, via a web crawler, a product offered by the shopping website, (ii) detecting, via the web crawler, an interactable element on the shopping website that allegedly enables purchase of the product, and (iii) attempting, via the web crawler, to purchase the product via each payment option.

In some embodiments, determining that at least one of the plurality of allegedly available payment options is suspicious may include identifying a trustworthiness score for each payment option within the allegedly available payment options and determining that the trustworthiness score for at least one payment option within the plurality of allegedly available payment options fails to satisfy a predetermined threshold. In some examples, the trustworthiness score for the shopping website may be calculated based at least in part on the trustworthiness score for each payment option within the plurality of allegedly available payment options.

In some examples, displaying the alert to the user based on the trustworthiness score of the shopping website may include warning the user that the shopping website is potentially fraudulent. Additionally or alternatively, displaying the alert to the user based on the trustworthiness score of the shopping website may include preventing the user from completing a transaction on the shopping website in response to determining that the trustworthiness score for the shopping website fails to satisfy a threshold for safe shopping websites.

In one embodiment, a system for detecting fraudulent shopping websites may include at least one physical processor and physical memory that includes computer-executable instructions that, when executed by the physical processor, cause the physical processor to (i) identify a shopping website that advertises a group of allegedly available payment options for completing transactions on the shopping website, (ii) determine, based at least in part on an analysis of the plurality of allegedly available payment options, that at least one of the allegedly available payment options is suspicious, (iii) calculate a trustworthiness score for the shopping website that is based at least in part on the determination that at least one of the allegedly available payment options is suspicious, and (iv) display an alert to a user based on the trustworthiness score of the shopping website.

In some examples, the above-described method may be encoded as computer-readable instructions on a non-transitory computer-readable medium. For example, a computer-readable medium may include one or more computer-executable instructions that, when executed by at least one processor of a computing device, may cause the computing device to (i) identify a shopping website that advertises a group of allegedly available payment options for completing transactions on the shopping website, (ii) determine, based at least in part on an analysis of the plurality of allegedly available payment options, that at least one of the allegedly available payment options is suspicious, (iii) calculate a trustworthiness score for the shopping website that is based at least in part on the determination that at least one of the allegedly available payment options is suspicious, and (iv) display an alert to a user based on the trustworthiness score of the shopping website.

Features from any of the embodiments described herein may be used in combination with one another in accordance with the general principles described herein. These and other embodiments, features, and advantages will be more fully understood upon reading the following detailed description in conjunction with the accompanying drawings and claims.

### BRIEF DESCRIPTION OF THE DRAWINGS

The accompanying drawings illustrate a number of example embodiments and are a part of the specification. Together with the following description, these drawings demonstrate and explain various principles of the present disclosure.

FIG. 1 is a block diagram of an example system for detecting fraudulent shopping websites.

FIG. 2 is a block diagram of an additional example system for detecting fraudulent shopping websites.

FIG. 3 is a flow diagram of an example method for detecting fraudulent shopping websites.

FIG. 4 is an illustration of an example shopping website.

FIG. 5 is a flow diagram of an example method for detecting fraudulent shopping websites.

FIG. 6 is a block diagram of an example computing system capable of implementing one or more of the embodiments described and/or illustrated herein.

FIG. 7 is a block diagram of an example computing network capable of implementing one or more of the embodiments described and/or illustrated herein.

Throughout the drawings, identical reference characters and descriptions indicate similar, but not necessarily identical, elements. While the example embodiments described herein are susceptible to various modifications and alternative forms, specific embodiments have been shown by way of example in the drawings and will be described in detail herein. However, the example embodiments described herein are not intended to be limited to the particular forms disclosed. Rather, the present disclosure covers all modifications, equivalents, and alternatives falling within the scope of the appended claims.

### DETAILED DESCRIPTION OF EXAMPLE EMBODIMENTS

The present disclosure is generally directed to systems and methods for detecting fraudulent shopping websites. As will be explained in greater detail below, by analyzing the payment options offered by shopping websites, the systems and methods described herein may be able to detect fraudulent websites that otherwise appear legitimate and may be missed by other website classifiers. By detecting fraudulent websites in this way, the systems and methods described herein may be able to improve and/or increase the classification accuracy of trustworthiness classifiers, thereby reducing the number of resulting false positives and/or false negatives, when compared to traditional classifiers that rely on user reviews, website format, website hosting, and/or other types of data.

In addition, the systems and methods described herein may improve the functionality of a computing device by detecting potentially fraudulent shopping websites with increased accuracy, resulting in an improved overall state of security for the computing device and thus protecting end users from potential scams. These systems and methods may also improve the field of online shopping and/or fraud detection by accurately identifying fraudulent shopping websites.

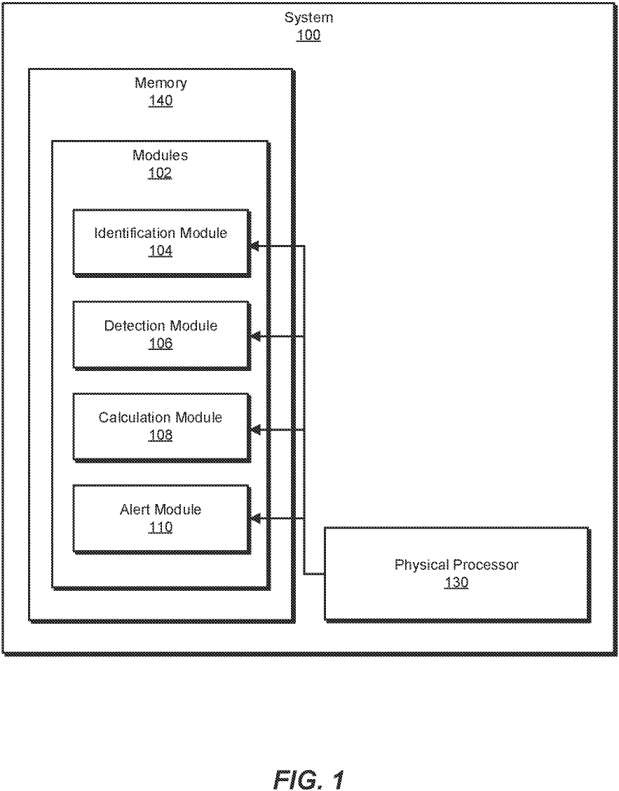

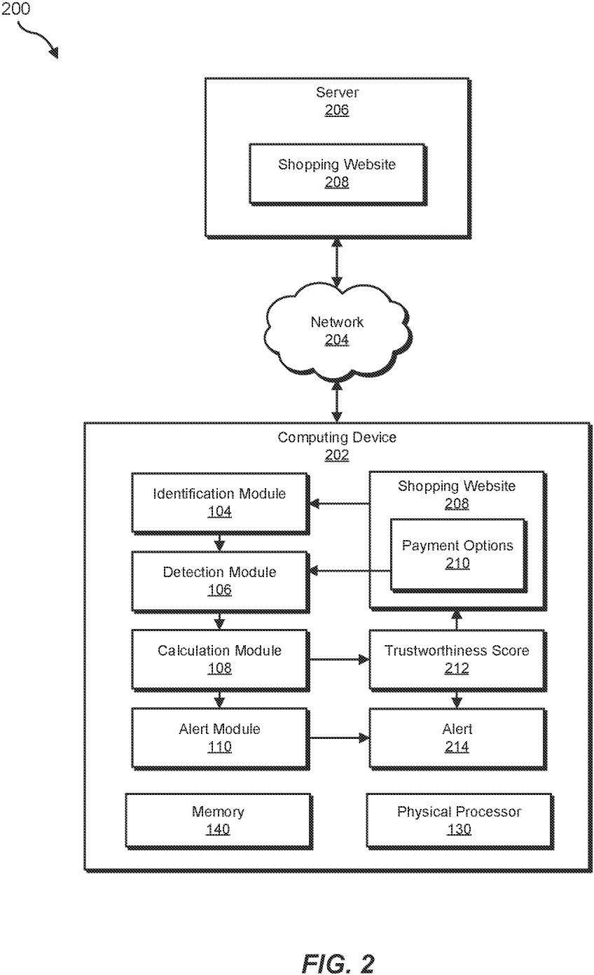

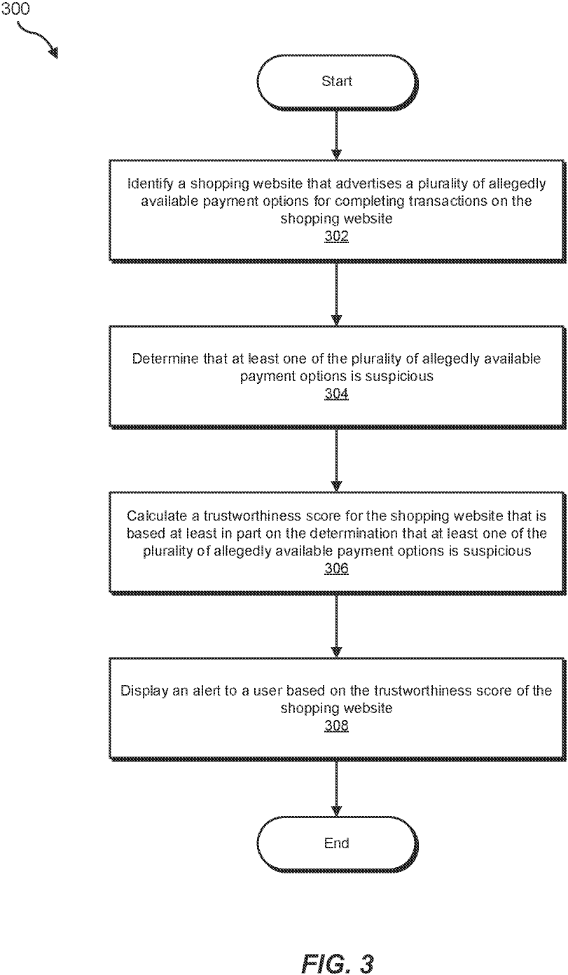

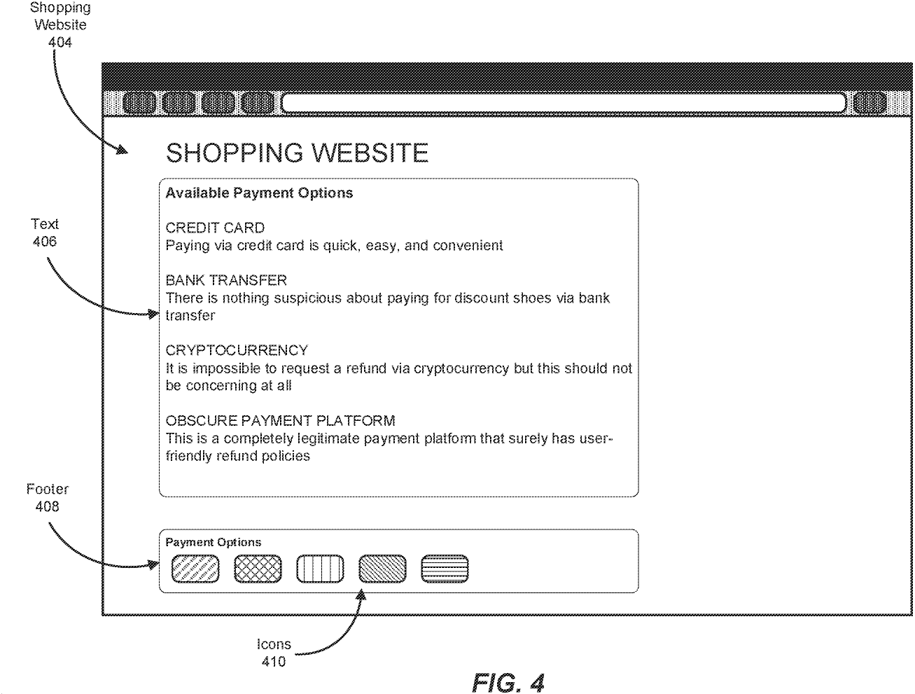

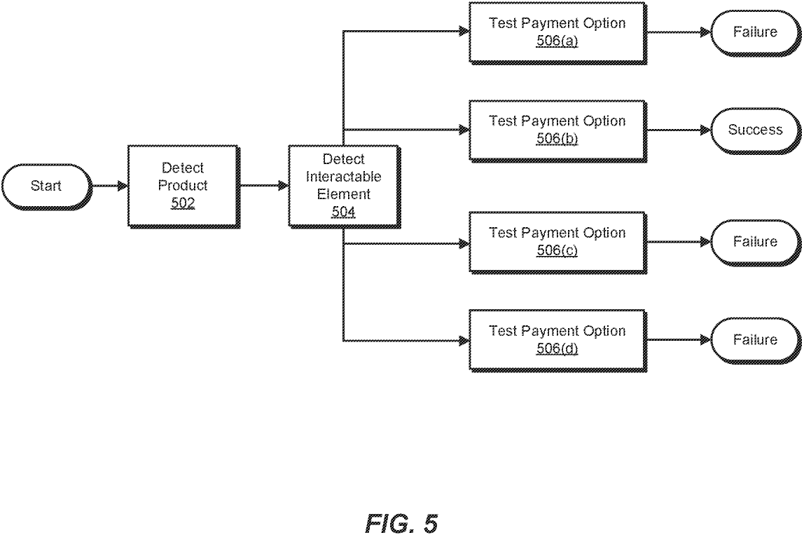

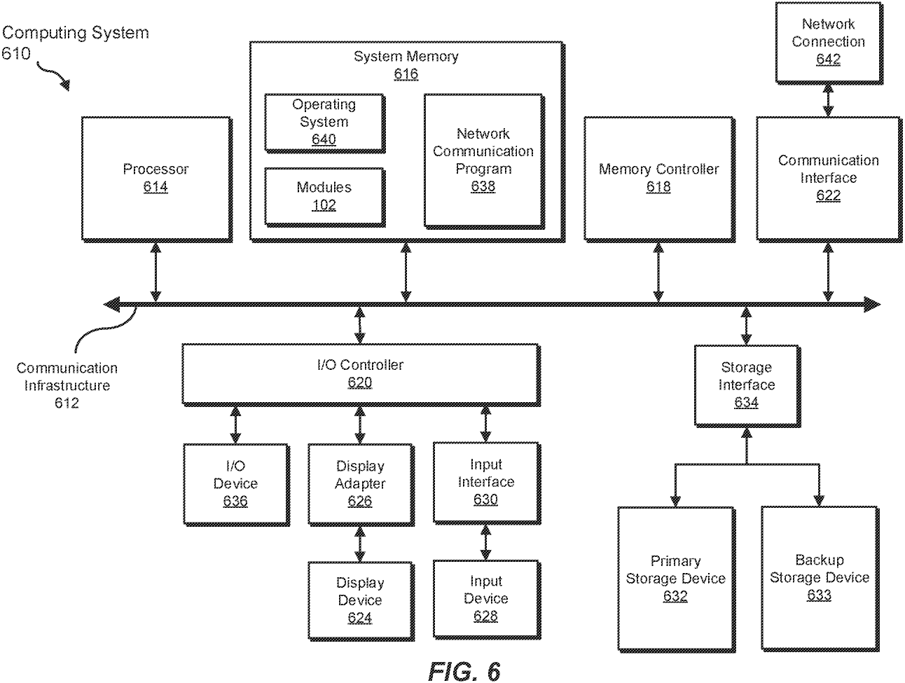

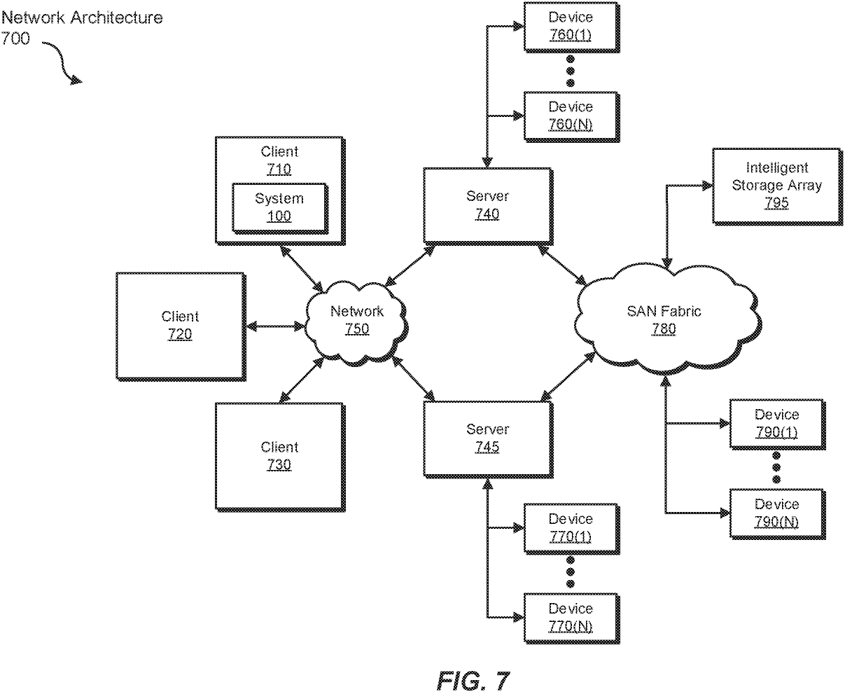

The following will provide, with reference to FIGS. 1-2, detailed descriptions of example systems for detecting fraudulent shopping websites. Detailed descriptions of an example shopping website will be provided in connection with FIG. 4. Detailed descriptions of corresponding computer-implemented methods will also be provided in connection with FIGS. 3 and 5. In addition, detailed descriptions of an example computing system and network architecture capable of implementing one or more of the embodiments described herein will be provided in connection with FIGS. 6 and 7, respectively.

FIG. 1 is a block diagram of an example system 100 for detecting fraudulent shopping websites. As illustrated in this figure, example system 100 may include one or more modules 102 for performing one or more tasks. For example, and as will be explained in greater detail below, example system 100 may include an identification module 104 that identifies a shopping website that advertises a plurality of allegedly available payment options for completing transactions on the shopping website. Example system 100 may additionally include a detection module 106 that determines, based at least in part on an analysis of the plurality of allegedly available payment options, that at least one of the plurality of allegedly available payment options is suspicious. Example system 100 may also include a calculation module 108 that calculates a trustworthiness score for the shopping website that is based at least in part on the determination that at least one of the plurality of allegedly available payment options is suspicious. Example system 100 may additionally include an alert module 110 that displays an alert to a user based on the trustworthiness score of the shopping website. Although illustrated as separate elements, one or more of modules 102 in FIG. 1 may represent portions of a single module or application.

In certain embodiments, one or more of modules 102 in FIG. 1 may represent one or more software applications or programs that, when executed by a computing device, may cause the computing device to perform one or more tasks. For example, and as will be described in greater detail below, one or more of modules 102 may represent modules stored and configured to run on one or more computing devices, such as the devices illustrated in FIG. 2 (e.g., computing device 202 and/or server 206). One or more of modules 102 in FIG. 1 may also represent all or portions of one or more special-purpose computers configured to perform one or more tasks.

As illustrated in FIG. 1, example system 100 may also include one or more memory devices, such as memory 140. Memory 140 generally represents any type or form of volatile or non-volatile storage device or medium capable of storing data and/or computer-readable instructions. In one example, memory 140 may store, load, and/or maintain one or more of modules 102. Examples of memory 140 include, without limitation, Random Access Memory (RAM), Read Only Memory (ROM), flash memory, Hard Disk Drives (HDDs), Solid-State Drives (SSDs), optical disk drives, caches, variations or combinations of one or more of the same, and/or any other suitable storage memory.

As illustrated in FIG. 1, example system 100 may also include one or more physical processors, such as physical processor 130. Physical processor 130 generally represents any type or form of hardware-implemented processing unit capable of interpreting and/or executing computer-readable instructions. In one example, physical processor 130 may access and/or modify one or more of modules 102 stored in memory 140. Additionally or alternatively, physical processor 130 may execute one or more of modules 102 to facilitate detecting fraudulent shopping websites. Examples of physical processor 130 include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, and/or any other suitable physical processor.

Example system 100 in FIG. 1 may be implemented in a variety of ways. For example, all or a portion of example system 100 may represent portions of example system 200 in FIG. 2. As shown in FIG. 2, system 200 may include a computing device 202 in communication with a server 206 via a network 204. In one example, all or a portion of the functionality of modules 102 may be performed by computing device 202, server 206, and/or any other suitable computing system. As will be described in greater detail below, one or more of modules 102 from FIG. 1 may, when executed by at least one processor of computing device 202 and/or server 206, enable computing device 202 and/or server 206 to detect fraudulent shopping websites. For example, and as will be described in greater detail below, identification module 104 may identify a shopping website 208 that advertises a plurality of allegedly available payment options 210 for completing transactions on the shopping website. Next, detection module 106 may determine that at least one of the payment options 210 offered on shopping website 208 is suspicious. Calculation module 108 may calculate a trustworthiness score 212 for shopping website 208 that is based at least in part on the determination that at least one of payment options 210 is suspicious. In some examples, alert module 110 may display an alert 214 to a user based on trustworthiness score 212 of shopping website 208.

Computing device 202 generally represents any type or form of computing device capable of reading computer-executable instructions. In some embodiments, computing device 202 may represent a personal computing device. Examples of computing device 202 include, without limitation, laptops, tablets, desktops, servers, cellular phones, Personal Digital Assistants (PDAs), multimedia players, embedded systems, wearable devices (e.g., smart watches, smart glasses, etc.), smart vehicles, smart packaging (e.g., active or intelligent packaging), gaming consoles, so-called Internet-of-Things devices (e.g., smart appliances, etc.), variations or combinations of one or more of the same, and/or any other suitable computing device.

Server 206 generally represents any type or form of computing device that is capable of hosting a shopping website. In some embodiments, server 206 may represent a dedicated e-commerce server. Additional examples of server 206 include, without limitation, security servers, application servers, web servers, storage servers, and/or database servers configured to run certain software applications and/or provide various security, web, storage, and/or database services. Although illustrated as a single entity in FIG. 2, server 206 may include and/or represent a plurality of servers that work and/or operate in conjunction with one another.

Network 204 generally represents any medium or architecture capable of facilitating communication or data transfer. In one example, network 204 may facilitate communication between computing device 202 and server 206. In this example, network 204 may facilitate communication or data transfer using wireless and/or wired connections. Examples of network 204 include, without limitation, an intranet, a Wide Area Network (WAN), a Local Area Network (LAN), a Personal Area Network (PAN), the Internet, Power Line Communications (PLC), a cellular network (e.g., a Global System for Mobile Communications (GSM) network), portions of one or more of the same, variations or combinations of one or more of the same, and/or any other suitable network.

Shopping website 208 generally represents any type or form of website and/or web application that lists one or more products that are allegedly available for purchase by users. In some examples, shopping website 208 may list discounted and/or knock-off versions of popular products, difficult-to-find niche products, and/or other desirable products.

Payment options 210 generally represents any type or form of services and/or platforms that process payment information. In some examples, payment options 210 may include, without limitation, credit card transaction processors, bank transfer processors, digital payment processors, cryptocurrency transaction processors, and/or any other suitable type of payment processor. In some examples, one or more of payment options 210 may include instructions on how to use the payment option, such as, “use the ‘friends and family' setting when sending your payment.”

Trustworthiness score 212 generally represents any type or form of classification of whether or not a website or payment option is likely fraudulent or suspicious. In some embodiments, trustworthiness score 212 may include a numeric value (e.g., a percentage likelihood that a shopping website is fraudulent). Additionally alternatively, trustworthiness score 212 may include a textual classification, such as “likely fraudulent,” “likely trustworthy,” or “very likely trustworthy.”

Alert 214 generally represents any type or form of notification to a user. In some embodiments, alert 214 may include trustworthiness score 212. Additionally or alternatively, alert 214 may include suggested actions for a user (e.g., “do not purchase from this website”). Examples of alert 214 may include, without limitation, a dialog window, a browser overlay, an interstitial page, and/or an in-app notification.

FIG. 3 is a flow diagram of an example computer-implemented method 300 for detecting fraudulent shopping websites. The steps shown in FIG. 3 may be performed by any suitable computer-executable code and/or computing system, including system 100 in FIG. 1, system 200 in FIG. 2, and/or variations or combinations of one or more of the same. In one example, each of the steps shown in FIG. 3 may represent an algorithm whose structure includes and/or is represented by multiple sub-steps, examples of which will be provided in greater detail below.

As illustrated in FIG. 3, at step 302, one or more of the systems described herein may identify a shopping website that advertises a plurality of allegedly available payment options for completing transactions on the shopping website. For example, identification module 104 may, as part of computing device 202 in FIG. 2, identify a shopping website 208 that advertises a plurality of allegedly available payment options 210 for completing transactions on shopping website 208.

Identification module 104 may identify a shopping website in a variety of ways and/or contexts. In some embodiments, identification module 104 may monitor websites loaded by a browser and/or app with Internet browsing functionality in order to identify shopping websites. In one embodiment, identification module 104 may be part of a browser plug-in. Additionally or alternatively, identification module 104 may be part of a security application (e.g., a firewall, and anti-malware application, etc.) that monitors Internet activities on a device. In some examples, identification module 104 may identify a shopping website by scanning the website for characteristics that indicate shopping. For example, identification module 104 may scan the website for shopping cart functionality, keywords related to shopping, mentions of payment options, and/or prices.

Identification module 104 may scan and/or analyze various parts of a shopping website to identify the payment options that are offered by the website. For example, as illustrated in FIG. 4, a shopping website 404 may include text 406 describing available payment options. In some examples, identification module 104 may identify the allegedly available payment options by analyzing text 406. For example, identification module 104 may analyze the text via natural language processing, such as a named entity recognition (NER) classifier trained to identify specific common payment options, including but not limited to particular online payment transfer services, banks, credit cards, and/or cryptocurrencies. In one embodiment, identification module 104 may use a web crawler to visit all links from the main page of a shopping website and feed the extracted text to an NER classifier.

Additionally or alternatively, identification module 104 may identify the allegedly available payment options by analyzing images on the shopping website. For example, shopping website 404 may have a footer 408 that includes icons 410 representing available payment options. In some examples, icons 410 may be located outside footer 408. In one embodiment, identification module 104 may identify the images on the shopping website by analyzing icons 410 via a deep learning image classification algorithm such as a residual network model. For example, identification module 104 may match icons 410 to the logos of popular payment options.

Returning to FIG. 3, at step 304, one or more of the systems described herein may determine that at least one of the plurality of allegedly available payment options is suspicious. For example, detection module 106 may, as part of computing device 202 in FIG. 2, detect that at least one of payment options 210 is suspicious.

Detection module 106 may determine that a payment option is suspicious in a variety of ways. In some embodiments, detection module 106 may determine that a payment option is suspicious if it is non-functional. For example, detection module 106 may attempt to complete a mock transaction with each payment option offered by a shopping website to determine whether all of the payment options are functional. In some examples, the systems described herein may complete enough steps of a mock transaction to verify whether a payment option is functional without completing the full transaction and being charged for the product. For example, the systems described herein may select a payment option, input payment information, and attempt to proceed to the next step, but may not activate a final “make order” button that completes the transaction.

In one embodiment, detection module 106 may use a web crawler to attempt to complete the mock transactions. For example, as illustrated in FIG. 5, at step 502 a web crawler may detect a product offered by the shopping website. In one embodiment, the web crawler may examine the structure of the document object model layer of the website to detect the product. In some examples, at step 504, the web crawler may detect an interactable element on the shopping website that allegedly enables purchase of the product. For example, the web crawler may detect an “add to cart” button and/or a “buy now” button. At steps 506(a)-(d), the web crawler may attempt to purchase the product via each payment option. In some embodiments, the web crawler may be trained in how to complete purchase processes based on data collected from multiple known legitimate and fraudulent shopping websites. In one example, the payment option testing at step 506(b) may result in a successful transaction, demonstrating that the payment option is functional, while all other payment options may result in failure. For example, a non-functional payment option may return an error when a transaction is attempted with that payment option.

In other examples, detection module 106 may determine that a payment option is suspicious if a trustworthiness score for the payment option fails to satisfy a predetermined threshold. For example, some payment options may be inherently less trustworthy than others, such as unusual or obscure payment options (such as cryptocurrency, travelers’ checks, gift cards, etc.), payment options that do not offer refunds, and/or payment options that are non-standard ways of using a payment service (e.g., marking a transfer as “sending to a friend” when the transfer is payment for a product). As such, in some examples calculation module 108 may calculate a trustworthiness score for each payment option 210 offered by shopping website 208. In these examples, if the trustworthiness score for a payment option fails to satisfy a predetermined threshold, then detection module 106 may determine that the payment option is suspicious.

Calculation module 108 may calculate trustworthiness scores for payment options in a variety of ways. In some examples, these trustworthiness scores may be based on the type of payment option being offered. For example, calculation model 108 may assign lower trustworthiness scores to unusual or obscure payment options (e.g., gift cards or travelers’ checks) than to more common payment options (e.g., credit cards). In another example, trustworthiness scores may be based on whether the payment option is being used in an unusual or non-standard way. For example, calculation module 108 may assign lower trustworthiness scores to payment options that are being used in unusual ways (e.g., marking a transfer as “sending to a friend” when the transfer is payment for a product). Calculation module 108 may also assign lower trustworthiness scores to payment options that do not offer refunds.

Returning to FIG. 3, at step 306, one or more of the systems described herein may calculate a trustworthiness score for the shopping website that is based at least in part on the determination in step 304 that at least one of the plurality of allegedly available payment options is suspicious. For example, calculation module 108 may, as part of computing device 202 in FIG. 2, calculate trustworthiness score 212 for shopping website 208 based at least in part on the determination by detection module 106 that at least one of payment options 210 is suspicious.

Calculation module 108 may calculate the trustworthiness score for shopping website 208 in a variety of ways. In one example, calculation module 108 may calculate the trustworthiness score based in part on what proportion (e.g., what percentage) of allegedly available payment options are non-functional. Similarly, calculation module 108 may calculate the trustworthiness score based in part on the total number of non-functional payment options.

Additionally or alternatively, calculation module 108 may calculate the trustworthiness score for the shopping website by identifying a trustworthiness score for each payment option and calculating the trustworthiness score for the shopping website based at least in part on the trustworthiness score for each payment option. For example, calculation module 108 may calculate a low trustworthiness score for a website that offers a large number and/or portion of non-trustworthy payment options. For example, if a website offers to let users pay via cryptocurrency, travelers’ checks, a payment service meant for sending money to friends, gift cards, and/or an obscure payment service that is not known to be trustworthy, calculation module 108 may calculate a low trustworthiness score for the website. By contrast, if a website offers to let users pay via credit card and/or popular and trusted online payment services used properly, calculation module 108 may calculate a high trustworthiness score for the website.

Calculation module 108 may also calculate the trustworthiness score for the shopping website based on a combination of the approaches described herein (e.g., based on whether the payment options offered are both functional and trustworthy). For example, if a website only permits users to pay via unusual or especially suspicious payment methods (such as non-refundable methods like bank transfer, gift cards, and/or cryptocurrency), calculation module 108 may calculate a low trustworthiness score for the website even if all of the payment options are functional. By contrast, if a website offers to let users pay via credit card and/or popular and trusted online payment services, calculation module 108 may still calculate a low trustworthiness score for the website if one or more of these payment options are non-functional. In some embodiments, calculation module 108 may generate a score based on the percentage and/or amount of available payment options that are non-functional, generate a score based on the trustworthiness of the payment options available, weight each score, and combine the waited scores to arrive at an overall trustworthiness score.

At step 308, one or more of the systems described herein may display an alert to a user based on the trustworthiness score of the shopping website. For example, alert module 110 may, as part of computing device 202 in FIG. 2, display alert 214 to a user based on trustworthiness score 212 of shopping website 208.

Alert module 110 may display the alert in a variety of different ways. For example, alert module 110 may display a pop-up, dialog box, and/or overlay in a browser and/or app indicating whether the shopping website is trustworthy.

In some examples, alert module 110 may display the alert to the user based on the trustworthiness score of the shopping website by warning the user that the shopping website is potentially fraudulent. In some embodiments, alert module 110 may only display the alert if the website has a trustworthiness score that fails to satisfy a predetermined threshold and may not display the alert otherwise.

In some embodiments, alert module 110 may display the alert to the user in response to determining that the trustworthiness score for the shopping website fails to satisfy a threshold for safe shopping websites. For example, alert module 110 may redirect the web browser from the shopping website to an alert page and/or may disable interactable elements of the shopping website (e.g., payment forms, transaction completion buttons, etc.). In some embodiments, the systems described herein may enable the user to complete a transaction after clicking through a warning.

As explained above in connection with method 300 in FIG. 3, the systems and methods described herein may detect fraudulent shopping websites by analyzing and testing the payment methods offered by such websites. In some cases, popular and trusted payment services have policies disallowing known fraudulent websites from using their services. As a result, fraudulent shopping websites may be unable to accept payments via credit card and other trusted online payment transfer services. Any website that offers a variety of less-trusted payment options and/or that allegedly offers popular payment options which turn out to be non-functional has a high probability of being a fraudulent website that is being prevented from using trusted, legitimate payment options. By analyzing and testing the payment options offered by a website, the systems described herein may accurately detect and protect consumers from fraudulent online shopping websites.

FIG. 6 is a block diagram of an example computing system 610 capable of implementing one or more of the embodiments described and/or illustrated herein. For example, all or a portion of computing system 610 may perform and/or be a means for performing, either alone or in combination with other elements, one or more of the steps described herein (such as one or more of the steps illustrated in FIG. 3). All or a portion of computing system 610 may also perform and/or be a means for performing any other steps, methods, or processes described and/or illustrated herein.

Computing system 610 broadly represents any single or multi-processor computing device or system capable of executing computer-readable instructions. Examples of computing system 610 include, without limitation, workstations, laptops, client-side terminals, servers, distributed computing systems, handheld devices, or any other computing system or device. In its most basic configuration, computing system 610 may include at least one processor 614 and a system memory 616.

Processor 614 generally represents any type or form of physical processing unit (e.g., a hardware-implemented central processing unit) capable of processing data or interpreting and executing instructions. In certain embodiments, processor 614 may receive instructions from a software application or module. These instructions may cause processor 614 to perform the functions of one or more of the example embodiments described and/or illustrated herein.

System memory 616 generally represents any type or form of volatile or non-volatile storage device or medium capable of storing data and/or other computer-readable instructions. Examples of system memory 616 include, without limitation, Random Access Memory (RAM), Read Only Memory (ROM), flash memory, or any other suitable memory device. Although not required, in certain embodiments computing system 610 may include both a volatile memory unit (such as, for example, system memory 616) and a non-volatile storage device (such as, for example, primary storage device 632, as described in detail below). In one example, one or more of modules 102 from FIG. 1 may be loaded into system memory 616.

In some examples, system memory 616 may store and/or load an operating system 640 for execution by processor 614. In one example, operating system 640 may include and/or represent software that manages computer hardware and software resources and/or provides common services to computer programs and/or applications on computing system 610. Examples of operating system 640 include, without limitation, LINUX, JUNOS, MICROSOFT WINDOWS, WINDOWS MOBILE, MAC OS, APPLE’S IOS, UNIX, GOOGLE CHROME OS, GOOGLE’S ANDROID, SOLARIS, variations of one or more of the same, and/or any other suitable operating system.

In certain embodiments, example computing system 610 may also include one or more components or elements in addition to processor 614 and system memory 616. For example, as illustrated in FIG. 6, computing system 610 may include a memory controller 618, an Input/Output (l/O) controller 620, and a communication interface 622, each of which may be interconnected via a communication infrastructure 612. Communication infrastructure 612 generally represents any type or form of infrastructure capable of facilitating communication between one or more components of a computing device. Examples of communication infrastructure 612 include, without limitation, a communication bus (such as an Industry Standard Architecture (ISA), Peripheral Component Interconnect (PCI), PCI Express (PCIe), or similar bus) and a network.

Memory controller 618 generally represents any type or form of device capable of handling memory or data or controlling communication between one or more components of computing system 610. For example, in certain embodiments memory controller 618 may control communication between processor 614, system memory 616, and l/O controller 620 via communication infrastructure 612.

l/O controller 620 generally represents any type or form of module capable of coordinating and/or controlling the input and output functions of a computing device. For example, in certain embodiments l/O controller 620 may control or facilitate transfer of data between one or more elements of computing system 610, such as processor 614, system memory 616, communication interface 622, display adapter 626, input interface 630, and storage interface 634.

As illustrated in FIG. 6, computing system 610 may also include at least one display device 624 coupled to l/O controller 620 via a display adapter 626. Display device 624 generally represents any type or form of device capable of visually displaying information forwarded by display adapter 626. Similarly, display adapter 626 generally represents any type or form of device configured to forward graphics, text, and other data from communication infrastructure 612 (or from a frame buffer, as known in the art) for display on display device 624.

As illustrated in FIG. 6, example computing system 610 may also include at least one input device 628 coupled to l/O controller 620 via an input interface 630. Input device 628 generally represents any type or form of input device capable of providing input, either computer or human generated, to example computing system 610. Examples of input device 628 include, without limitation, a keyboard, a pointing device, a speech recognition device, variations or combinations of one or more of the same, and/or any other input device.

Additionally or alternatively, example computing system 610 may include additional l/O devices. For example, example computing system 610 may include l/O device 636. In this example, l/O device 636 may include and/or represent a user interface that facilitates human interaction with computing system 610. Examples of l/O device 636 include, without limitation, a computer mouse, a keyboard, a monitor, a printer, a modem, a camera, a scanner, a microphone, a touchscreen device, variations or combinations of one or more of the same, and/or any other l/O device.

Communication interface 622 broadly represents any type or form of communication device or adapter capable of facilitating communication between example computing system 610 and one or more additional devices. For example, in certain embodiments communication interface 622 may facilitate communication between computing system 610 and a private or public network including additional computing systems. Examples of communication interface 622 include, without limitation, a wired network interface (such as a network interface card), a wireless network interface (such as a wireless network interface card), a modem, and any other suitable interface. In at least one embodiment, communication interface 622 may provide a direct connection to a remote server via a direct link to a network, such as the Internet. Communication interface 622 may also indirectly provide such a connection through, for example, a local area network (such as an Ethernet network), a personal area network, a telephone or cable network, a cellular telephone connection, a satellite data connection, or any other suitable connection.

In certain embodiments, communication interface 622 may also represent a host adapter configured to facilitate communication between computing system 610 and one or more additional network or storage devices via an external bus or communications channel. Examples of host adapters include, without limitation, Small Computer System Interface (SCSI) host adapters, Universal Serial Bus (USB) host adapters, Institute of Electrical and Electronics Engineers (IEEE) 1394 host adapters, Advanced Technology Attachment (ATA), Parallel ATA (PATA), Serial ATA (SATA), and External SATA (eSATA) host adapters, Fibre Channel interface adapters, Ethernet adapters, or the like. Communication interface 622 may also allow computing system 610 to engage in distributed or remote computing. For example, communication interface 622 may receive instructions from a remote device or send instructions to a remote device for execution.

In some examples, system memory 616 may store and/or load a network communication program 638 for execution by processor 614. In one example, network communication program 638 may include and/or represent software that enables computing system 610 to establish a network connection 642 with another computing system (not illustrated in FIG. 6) and/or communicate with the other computing system by way of communication interface 622. In this example, network communication program 638 may direct the flow of outgoing traffic that is sent to the other computing system via network connection 642. Additionally or alternatively, network communication program 638 may direct the processing of incoming traffic that is received from the other computing system via network connection 642 in connection with processor 614.

Although not illustrated in this way in FIG. 6, network communication program 638 may alternatively be stored and/or loaded in communication interface 622. For example, network communication program 638 may include and/or represent at least a portion of software and/or firmware that is executed by a processor and/or Application Specific Integrated Circuit (ASIC) incorporated in communication interface 622.

As illustrated in FIG. 6, example computing system 610 may also include a primary storage device 632 and a backup storage device 633 coupled to communication infrastructure 612 via a storage interface 634. Storage devices 632 and 633 generally represent any type or form of storage device or medium capable of storing data and/or other computer-readable instructions. For example, storage devices 632 and 633 may be a magnetic disk drive (e.g., a so-called hard drive), a solid state drive, a floppy disk drive, a magnetic tape drive, an optical disk drive, a flash drive, or the like. Storage interface 634 generally represents any type or form of interface or device for transferring data between storage devices 632 and 633 and other components of computing system 610.

In certain embodiments, storage devices 632 and 633 may be configured to read from and/or write to a removable storage unit configured to store computer software, data, or other computer-readable information. Examples of suitable removable storage units include, without limitation, a floppy disk, a magnetic tape, an optical disk, a flash memory device, or the like. Storage devices 632 and 633 may also include other similar structures or devices for allowing computer software, data, or other computer-readable instructions to be loaded into computing system 610. For example, storage devices 632 and 633 may be configured to read and write software, data, or other computer-readable information. Storage devices 632 and 633 may also be a part of computing system 610 or may be a separate device accessed through other interface systems.

Many other devices or subsystems may be connected to computing system 610. Conversely, all of the components and devices illustrated in FIG. 6 need not be present to practice the embodiments described and/or illustrated herein. The devices and subsystems referenced above may also be interconnected in different ways from that shown in FIG. 6. Computing system 610 may also employ any number of software, firmware, and/or hardware configurations. For example, one or more of the example embodiments disclosed herein may be encoded as a computer program (also referred to as computer software, software applications, computer-readable instructions, or computer control logic) on a computer-readable medium. The term “computer-readable medium,” as used herein, generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The computer-readable medium containing the computer program may be loaded into computing system 610. All or a portion of the computer program stored on the computer-readable medium may then be stored in system memory 616 and/or various portions of storage devices 632 and 633. When executed by processor 614, a computer program loaded into computing system 610 may cause processor 614 to perform and/or be a means for performing the functions of one or more of the example embodiments described and/or illustrated herein. Additionally or alternatively, one or more of the example embodiments described and/or illustrated herein may be implemented in firmware and/or hardware. For example, computing system 610 may be configured as an Application Specific Integrated Circuit (ASIC) adapted to implement one or more of the example embodiments disclosed herein.

FIG. 7 is a block diagram of an example network architecture 700 in which client systems 710, 720, and 730 and servers 740 and 745 may be coupled to a network 750. As detailed above, all or a portion of network architecture 700 may perform and/or be a means for performing, either alone or in combination with other elements, one or more of the steps disclosed herein (such as one or more of the steps illustrated in FIG. 3). All or a portion of network architecture 700 may also be used to perform and/or be a means for performing other steps and features set forth in the present disclosure.

Client systems 710, 720, and 730 generally represent any type or form of computing device or system, such as example computing system 610 in FIG. 6. Similarly, servers 740 and 745 generally represent computing devices or systems, such as application servers or database servers, configured to provide various database services and/or run certain software applications. Network 750 generally represents any telecommunication or computer network including, for example, an intranet, a WAN, a LAN, a PAN, or the Internet. In one example, client systems 710, 720, and/or 730 and/or servers 740 and/or 745 may include all or a portion of system 100 from FIG. 1.

As illustrated in FIG. 7, one or more storage devices 760(1)-(N) may be directly attached to server 740. Similarly, one or more storage devices 770(1)-(N) may be directly attached to server 745. Storage devices 760(1)-(N) and storage devices 770(1)-(N) generally represent any type or form of storage device or medium capable of storing data and/or other computer-readable instructions. In certain embodiments, storage devices 760(1)-(N) and storage devices 770(1)-(N) may represent Network-Attached Storage (NAS) devices configured to communicate with servers 740 and 745 using various protocols, such as Network File System (NFS), Server Message Block (SMB), or Common Internet File System (CIFS).

Servers 740 and 745 may also be connected to a Storage Area Network (SAN) fabric 780. SAN fabric 780 generally represents any type or form of computer network or architecture capable of facilitating communication between a plurality of storage devices. SAN fabric 780 may facilitate communication between servers 740 and 745 and a plurality of storage devices 790(1)-(N) and/or an intelligent storage array 795. SAN fabric 780 may also facilitate, via network 750 and servers 740 and 745, communication between client systems 710, 720, and 730 and storage devices 790(1)-(N) and/or intelligent storage array 795 in such a manner that devices 790(1)-(N) and array 795 appear as locally attached devices to client systems 710, 720, and 730. As with storage devices 760(1)-(N) and storage devices 770(1)-(N), storage devices 790(1)-(N) and intelligent storage array 795 generally represent any type or form of storage device or medium capable of storing data and/or other computer-readable instructions.

In certain embodiments, and with reference to example computing system 610 of FIG. 6, a communication interface, such as communication interface 622 in FIG. 6, may be used to provide connectivity between each client system 710, 720, and 730 and network 750. Client systems 710, 720, and 730 may be able to access information on server 740 or 745 using, for example, a web browser or other client software. Such software may allow client systems 710, 720, and 730 to access data hosted by server 740, server 745, storage devices 760(1)-(N), storage devices 770(1)-(N), storage devices 790(1)-(N), or intelligent storage array 795. Although FIG. 7 depicts the use of a network (such as the Internet) for exchanging data, the embodiments described and/or illustrated herein are not limited to the Internet or any particular network-based environment.

In at least one embodiment, all or a portion of one or more of the example embodiments disclosed herein may be encoded as a computer program and loaded onto and executed by server 740, server 745, storage devices 760(1)-(N), storage devices 770(1)-(N), storage devices 790(1)-(N), intelligent storage array 795, or any combination thereof. All or a portion of one or more of the example embodiments disclosed herein may also be encoded as a computer program, stored in server 740, run by server 745, and distributed to client systems 710, 720, and 730 over network 750.

As detailed above, computing system 610 and/or one or more components of network architecture 700 may perform and/or be a means for performing, either alone or in combination with other elements, one or more steps of an example method for detecting fraudulent shopping websites.

While the foregoing disclosure sets forth various embodiments using specific block diagrams, flowcharts, and examples, each block diagram component, flowchart step, operation, and/or component described and/or illustrated herein may be implemented, individually and/or collectively, using a wide range of hardware, software, or firmware (or any combination thereof) configurations. In addition, any disclosure of components contained within other components should be considered example in nature since many other architectures can be implemented to achieve the same functionality.

In some examples, all or a portion of example system 100 in FIG. 1 may represent portions of a cloud-computing or network-based environment. Cloud-computing environments may provide various services and applications via the Internet. These cloud-based services (e.g., software as a service, platform as a service, infrastructure as a service, etc.) may be accessible through a web browser or other remote interface. Various functions described herein may be provided through a remote desktop environment or any other cloud-based computing environment.

In various embodiments, all or a portion of example system 100 in FIG. 1 may facilitate multi-tenancy within a cloud-based computing environment. In other words, the software modules described herein may configure a computing system (e.g., a server) to facilitate multi-tenancy for one or more of the functions described herein. For example, one or more of the software modules described herein may program a server to enable two or more clients (e.g., customers) to share an application that is running on the server. A server programmed in this manner may share an application, operating system, processing system, and/or storage system among multiple customers (i.e., tenants). One or more of the modules described herein may also partition data and/or configuration information of a multi-tenant application for each customer such that one customer cannot access data and/or configuration information of another customer.

According to various embodiments, all or a portion of example system 100 in FIG. 1 may be implemented within a virtual environment. For example, the modules and/or data described herein may reside and/or execute within a virtual machine. As used herein, the term “virtual machine” generally refers to any operating system environment that is abstracted from computing hardware by a virtual machine manager (e.g., a hypervisor). Additionally or alternatively, the modules and/or data described herein may reside and/or execute within a virtualization layer. As used herein, the term “virtualization layer” generally refers to any data layer and/or application layer that overlays and/or is abstracted from an operating system environment. A virtualization layer may be managed by a software virtualization solution (e.g., a file system filter) that presents the virtualization layer as though it were part of an underlying base operating system. For example, a software virtualization solution may redirect calls that are initially directed to locations within a base file system and/or registry to locations within a virtualization layer.

In some examples, all or a portion of example system 100 in FIG. 1 may represent portions of a mobile computing environment. Mobile computing environments may be implemented by a wide range of mobile computing devices, including mobile phones, tablet computers, e-book readers, personal digital assistants, wearable computing devices (e.g., computing devices with a head-mounted display, smartwatches, etc.), and the like. In some examples, mobile computing environments may have one or more distinct features, including, for example, reliance on battery power, presenting only one foreground application at any given time, remote management features, touchscreen features, location and movement data (e.g., provided by Global Positioning Systems, gyroscopes, accelerometers, etc.), restricted platforms that restrict modifications to system-level configurations and/or that limit the ability of third-party software to inspect the behavior of other applications, controls to restrict the installation of applications (e.g., to only originate from approved application stores), etc. Various functions described herein may be provided for a mobile computing environment and/or may interact with a mobile computing environment.

In addition, all or a portion of example system 100 in FIG. 1 may represent portions of, interact with, consume data produced by, and/or produce data consumed by one or more systems for information management. As used herein, the term “information management” may refer to the protection, organization, and/or storage of data. Examples of systems for information management may include, without limitation, storage systems, backup systems, archival systems, replication systems, high availability systems, data search systems, virtualization systems, and the like.

In some embodiments, all or a portion of example system 100 in FIG. 1 may represent portions of, produce data protected by, and/or communicate with one or more systems for information security. As used herein, the term “information security” may refer to the control of access to protected data. Examples of systems for information security may include, without limitation, systems providing managed security services, data loss prevention systems, identity authentication systems, access control systems, encryption systems, policy compliance systems, intrusion detection and prevention systems, electronic discovery systems, and the like.

According to some examples, all or a portion of example system 100 in FIG. 1 may represent portions of, communicate with, and/or receive protection from one or more systems for endpoint security. As used herein, the term “endpoint security” may refer to the protection of endpoint systems from unauthorized and/or illegitimate use, access, and/or control. Examples of systems for endpoint protection may include, without limitation, anti-malware systems, user authentication systems, encryption systems, privacy systems, spam-filtering services, and the like.

The process parameters and sequence of steps described and/or illustrated herein are given by way of example only and can be varied as desired. For example, while the steps illustrated and/or described herein may be shown or discussed in a particular order, these steps do not necessarily need to be performed in the order illustrated or discussed. The various example methods described and/or illustrated herein may also omit one or more of the steps described or illustrated herein or include additional steps in addition to those disclosed.

While various embodiments have been described and/or illustrated herein in the context of fully functional computing systems, one or more of these example embodiments may be distributed as a program product in a variety of forms, regardless of the particular type of computer-readable media used to actually carry out the distribution. The embodiments disclosed herein may also be implemented using software modules that perform certain tasks. These software modules may include script, batch, or other executable files that may be stored on a computer-readable storage medium or in a computing system. In some embodiments, these software modules may configure a computing system to perform one or more of the example embodiments disclosed herein.

In addition, one or more of the modules described herein may transform data, physical devices, and/or representations of physical devices from one form to another. For example, one or more of the modules recited herein may receive website or web app data to be transformed, transform the data to identify payment options, output a result of the transformation to a web crawler, use the result of the transformation to test payment options, and store the result of the transformation to calculate a trustworthiness score. Additionally or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

The preceding description has been provided to enable others skilled in the art to best utilize various aspects of the example embodiments disclosed herein. This example description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A computer-implemented method for detecting fraudulent shopping websites, at least a portion of the method being performed by a computing device comprising at least one processor, the method comprising:
identifying a shopping website that advertises a plurality of allegedly available payment options for completing transactions on the shopping website;
determining, based at least in part on an analysis of the plurality of allegedly available payment options, that at least one of the plurality of allegedly available payment options is suspicious;
calculating a trustworthiness score for the shopping website that is based at least in part on the determination that at least one of the allegedly available payment options is suspicious; and
displaying an alert to a user based on the trustworthiness score of the shopping website.

2. The computer-implemented method of claim 1, wherein identifying the shopping website that advertises the plurality of allegedly available payment options comprises identifying the allegedly available payment options by at least one of:
analyzing text of the shopping website; or
analyzing images on the shopping website.

3. The computer-implemented method of claim 2, wherein analyzing the text of the shopping website comprises analyzing the text via a named entity recognition classifier.

4. The computer-implemented method of claim 2, wherein analyzing the images on the shopping website comprises analyzing the images via a deep learning image classification algorithm.

5. The computer-implemented method of claim 1, wherein determining that at least one of the plurality of allegedly available payment options is suspicious comprises detecting that at least a portion of the plurality of allegedly available payment options are non-functional.

6. The computer-implemented method of claim 5, wherein detecting that at least a portion of the plurality of allegedly available payment options are non-functional comprises attempting to complete a mock transaction with each payment option within the plurality of allegedly available payment options by:
detecting, via a web crawler, a product offered by the shopping website;
detecting, via the web crawler, an interactable element on the shopping website that allegedly enables purchase of the product; and
attempting, via the web crawler, to purchase the product via each payment option.

7. The computer-implemented method of claim 1, wherein determining that at least one of the plurality of allegedly available payment options is suspicious comprises:
identifying a trustworthiness score for each payment option within the plurality of allegedly available payment options; and
determining that the trustworthiness score for at least one payment option within the plurality of allegedly available payment options fails to satisfy a predetermined threshold.

8. The computer-implemented method of claim 7, wherein the trustworthiness score for the shopping website is calculated based at least in part on the trustworthiness score for each payment option within the plurality of allegedly available payment options.

9. The computer-implemented method of claim 1, wherein displaying the alert to the user based on the trustworthiness score of the shopping website comprises warning the user that the shopping website is potentially fraudulent.

10. The computer-implemented method of claim 1, wherein displaying the alert to the user based on the trustworthiness score of the shopping website comprises preventing the user from completing a transaction on the shopping website in response to determining that the trustworthiness score for the shopping website fails to satisfy a threshold for safe shopping websites.

11. A system for detecting fraudulent shopping websites, the system comprising:
at least one physical processor;
physical memory comprising computer-executable instructions that, when executed by the physical processor, cause the physical processor to:
identify a shopping website that advertises a plurality of allegedly available payment options for completing transactions on the shopping website;
determine, based at least in part on an analysis of the plurality of allegedly available payment options, that at least one of the plurality of allegedly available payment options is suspicious;
calculate a trustworthiness score for the shopping website that is based at least in part on the determination that at least one of the allegedly available payment options is suspicious; and
display an alert to a user based on the trustworthiness score of the shopping website.

12. The system of claim 11, wherein identifying the shopping website that advertises the plurality of allegedly available payment options comprises identifying the allegedly available payment options by at least one of:
analyzing text of the shopping website; or
analyzing images on the shopping website.

13. The system of claim 12, wherein analyzing the text of the shopping website comprises analyzing the text via a named entity recognition classifier.

14. The system of claim 12, wherein analyzing the images on the shopping website comprises analyzing the images via a deep learning image classification algorithm.

15. The system of claim 11, wherein determining that at least one of the plurality of allegedly available payment options is suspicious comprises detecting that at least a portion of the plurality of allegedly available payment options are non-functional.

16. The system of claim 15, wherein detecting that at least a portion of the plurality of allegedly available payment options are non-functional comprises attempting to complete a mock transaction with each payment option within the plurality of allegedly available payment options by:
detecting, via a web crawler, a product offered by the shopping website;
detecting, via the web crawler, an interactable element on the shopping website that allegedly enables purchase of the product; and
attempting, via the web crawler, to purchase the product via each payment option.

17. The system of claim 11, wherein determining that at least one of the plurality of allegedly available payment options is suspicious comprises:
identifying a trustworthiness score for each payment option within the plurality of allegedly available payment options; and
determining that the trustworthiness score for at least one payment option within the plurality of allegedly available payment options fails to satisfy a predetermined threshold.

18. The system of claim 17, wherein the trustworthiness score for the shopping website is calculated based at least in part on the trustworthiness score for each payment option within the plurality of allegedly available payment options.

19. The system of claim 11, wherein displaying the alert to the user based on the trustworthiness score of the shopping website comprises warning the user that the shopping website is potentially fraudulent.

20. A non-transitory computer-readable medium comprising one or more computer-executable instructions that, when executed by at least one processor of a computing device, cause the computing device to:
identify a shopping website that advertises a plurality of allegedly available payment options for completing transactions on the shopping website;
determine, based at least in part on an analysis of the plurality of allegedly available payment options, that at least one of the plurality of allegedly available payment options is suspicious;
calculate a trustworthiness score for the shopping website based at least in part on the determination that at least one of the plurality of allegedly available payment options is suspicious; and
display an alert to a user based on the trustworthiness score of the shopping website.
